(19) United States
(12) Patent Application Publication
(10) Pub. No.: US 2010/0135817 A1
(43) Pub. Date: Jun. 3, 2010

(54) WIND TURBINE BLADE AND METHOD FOR MANUFACTURING THEREOF

(76) Inventors: John C. Wirt, Mendota Heights, MN (US); Gregory T. Telesz, New Castle, PA (US)

Correspondence Address: MERCHANT & GOULD PC, P.O. BOX 2903, MINNEAPOLIS, MN, 55402-0903, US

(21) Appl. No.: 12/603,667

(22) Filed: Oct. 22, 2009

Related U.S. Application Data
(60) Provisional application No. 61/107,575, filed on Oct. 22, 2008.

(51) Int. Cl. F03D 1/06; B29C 70/70

(52) U.S. Cl. 416/226; 156/156; 156/242

(57) ABSTRACT

A wind turbine blade includes an upper shell with a first portion molded to a second portion by a seamless connection extending along at least a majority of the width of the upper shell. The wind turbine blade also includes a lower shell with a third portion molded to a fourth portion by a seamless connection extending along at least a majority of the width of the lower shell. The first, second, third and fourth portions are made of a fiber reinforced resin construction. A first insert is enveloped within the upper shell between the first portion and the second portion, the enveloped first insert defining a first spar portion. A second insert is enveloped within the lower shell between the third portion and the fourth portion, the enveloped second insert defining a second spar portion. The inserts defining a density lower than the density of the fiber reinforced resin material. The upper shell is bonded to the lower shell adjacent the right and left sides thereof. The first spar portion is also bonded to the second spar portion to form a reinforcement structure of the wind turbine blade.

### CROSS REFERENCE TO RELATED APPLICATION

This application claims the benefit of provisional application Ser. No. 61/107,575, filed Oct. 22, 2008, which is incorporated herein by reference in its entirety.

### FIELD

The present disclosure relates generally to blades for wind energy turbines and method of manufacturing thereof. More particularly, the present disclosure relates to wind turbine blades manufactured or molded with an integrally formed reinforcement structure.

### BACKGROUND

Recently, wind turbines have received increased attention as environmentally safe and relatively inexpensive alternative energy sources. Considerable efforts are being made to develop wind turbines that are reliable and efficient.

Generally, a wind turbine includes a rotor with multiple wind turbine blades. The wind turbine blades are shaped as elongated airfoils configured to provide rotational forces in response to wind. The rotor is mounted to a housing or nacelle, which is positioned on top of a tower, which can reach heights of 60 meters or more.

These wind turbine blades transform wind energy into a rotational torque or force that drives one or more generators. The generators may be rotationally coupled to the rotor through a gearbox. The gearbox steps up the low rotational speed of the turbine rotor for the generator to efficiently convert mechanical energy into electrical energy. The electrical energy can then be fed into a utility grid.

Wind turbine blades may be very large and typically are fabricated utilizing lay-up composite fabrication techniques. For example, one method may infuse two outer shells of fiberglass with resin. Once the two shells have been cured, preformed reinforcement structures such as shear webs may be bonded to the shells.

The bonding typically utilizes adhesives, such as epoxy or other suitable adhesives. These fabrication methods suffer from the drawbacks of having weaker reinforcement portions of the blade as well as increased complexity and time in forming the blades.

Improved methods for fabricating wind turbine blades that result in stronger reinforcement structures are desired.

### SUMMARY

One aspect of the present disclosure relates to a wind turbine blade molded with an integrally formed reinforcement structure and a method for fabrication thereof.

According to another aspect, the present disclosure relates to a wind turbine blade including an upper shell with a first portion molded to a second portion by a seamless connection extending along at least a majority of the width of the upper shell. The wind turbine blade also includes a lower shell with a third portion molded to a fourth portion by a seamless connection extending along at least a majority of the width of the lower shell. The first, second, third and fourth portions are made of a fiber reinforced resin construction. A first insert is enveloped within the upper shell between the first portion and the second portion, the enveloped first insert defining a first spar portion. A second insert is enveloped within the lower shell between the third portion and the fourth portion, the enveloped second insert defining a second spar portion. The inserts defining a density lower than the density of the fiber reinforced resin material. The upper shell is bonded to the lower shell adjacent the right and left sides thereof. The first spar portion is also bonded to the second spar portion to form a reinforcement structure of the wind turbine blade.

A variety of advantages of the inventive aspects of the disclosure will be set forth in the description that follows, and in part will be apparent from the description, or may be learned by practicing the inventive aspects of the disclosure. It is to be understood that both the foregoing general description and the following detailed description are exemplary and explanatory only and are not restrictive of the inventive aspects claimed.

### BRIEF DESCRIPTION OF THE DRAWINGS

The accompanying drawings, which are incorporated in and constitute a part of this specification, illustrate several aspects of the disclosure and together with the description, serve to explain the principles of the inventive aspects of the disclosure. A brief description of the drawings is as follows:

FIG. 1 is a drawing of an exemplary configuration of a wind turbine;

FIG. 2 is a perspective view of a wind turbine blade having features that are examples of inventive aspects in accordance with the principles of the present disclosure;

FIG. 3 is a cross-sectional view taken along line 3-3 of FIG. 2;

FIG. 3A is a cross-sectional view of an alternative embodiment of a wind turbine blade taken along a line similar to line 3-3 of FIG. 2;

FIG. 4 is a schematic cross-sectional view of a resin transfer molding cell suitable for fabricating the upper shell of the wind turbine blade of FIG. 3;

FIG. 5 is a schematic cross-sectional view of a resin transfer molding cell suitable for fabricating the lower shell of the wind turbine blade of FIG. 3; and

FIG. 6 is an exploded view of portions of the male and female mold pieces used for fabricating each of the upper and the lower shells of the wind turbine blade of FIG. 3, with fibrous reinforcing material and pre-formed inserts positioned between the mold pieces.

### DETAILED DESCRIPTION

Reference will now be made in detail to examples of inventive aspects in accordance with the principles of the present disclosure that are illustrated in the accompanying drawings. Wherever possible, the same reference numbers will be used throughout the drawings to refer to the same or like parts.

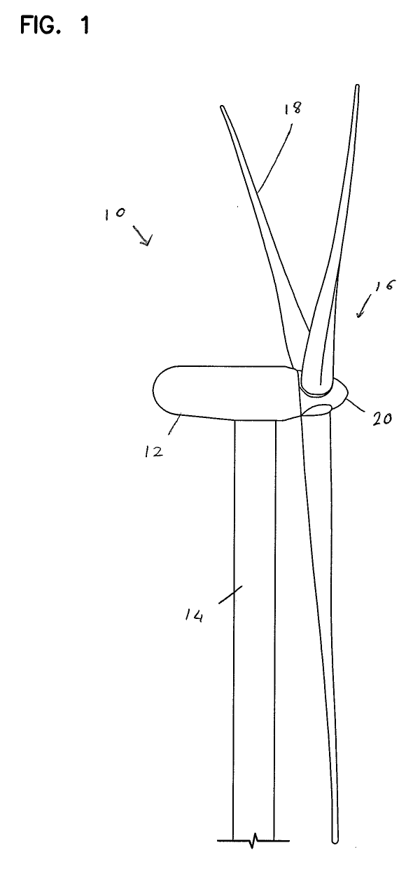

FIG. 1 shows an exemplary wind turbine 10 having a nacelle 12 housing a generator (not shown). Nacelle 12 is a housing mounted on top of a tower 14, only a portion of which is shown in FIG. 1. The height of the tower 14 may be selected based upon factors and conditions known in the art, and may extend to heights up to 60 meters or more. The wind turbine 10 may be installed at any location providing access to areas having desirable wind conditions. The locations may vary greatly and may include, but is not limited to, mountainous terrain or off-shore locations. The wind turbine 10 also includes a rotor 16 that includes one or more blades 18 attached to a rotating hub 20.

Although the wind turbine 10 in FIG. 1 is depicted as including three blades 18, there are no specific limits on the number of blades that may be used in accordance with the present disclosure.

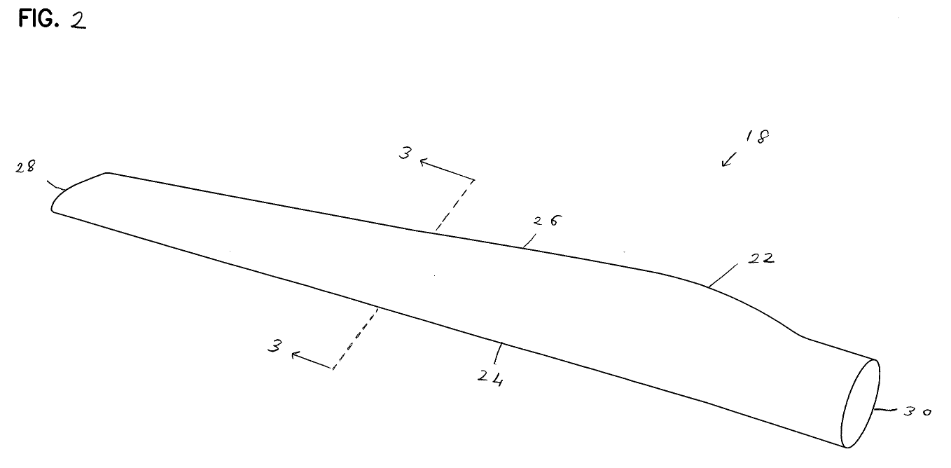

FIG. 2 illustrates a perspective view of a turbine blade 18 having features that are examples of inventive aspects in accordance with the principles of the present disclosure. Referring to FIG. 2, the turbine blade 18 includes a body 22 defining a leading edge 24 and a trailing edge 26. The body 22 extends from an outer end 28 to an inner end 30. The inner end 30 may be called the root portion of the turbine blade 18, which is configured to be connectable to the hub 20 of the wind turbine 10. The root portion normally includes fastening structures for coupling the blade 18 to the hub 20 of the wind turbine 10. The fastening structures may include structures such as T-bolts that are embedded or formed into the root portion of the turbine blade 18. Other fastening structures known in the art are certainly possible.

Still referring to FIG. 2, the cross-sectional configuration of the body 22 changes as the body extends between the outer end 28 and the inner end 30. For example, the inner end 30 that is configured to be mounted to the hub 20 of the wind turbine 10 may include a circular cross-section. In this manner, when the inner end 30 is fastened to the hub 20 with fasteners, the load on the blade 18 can be distributed evenly around the perimeter of the inner end 30. The rest of the body 22 may be configured in accordance with the principles known in the art in order to efficiently transform wind energy into a rotational torque or force that drives one or more generators that may coupled to the rotor 16 of the turbine 10.

It should be noted that wind turbine blades such as the blade 18 described in the present disclosure may be provided in a variety of different shapes and sizes in accordance with their desired use, location, and other factors. The blade design illustrated and described herein is simply an exemplary configuration and should not be used to limit the scope of the disclosure that relates to the manufacturing techniques and structural aspects of the blade 18.

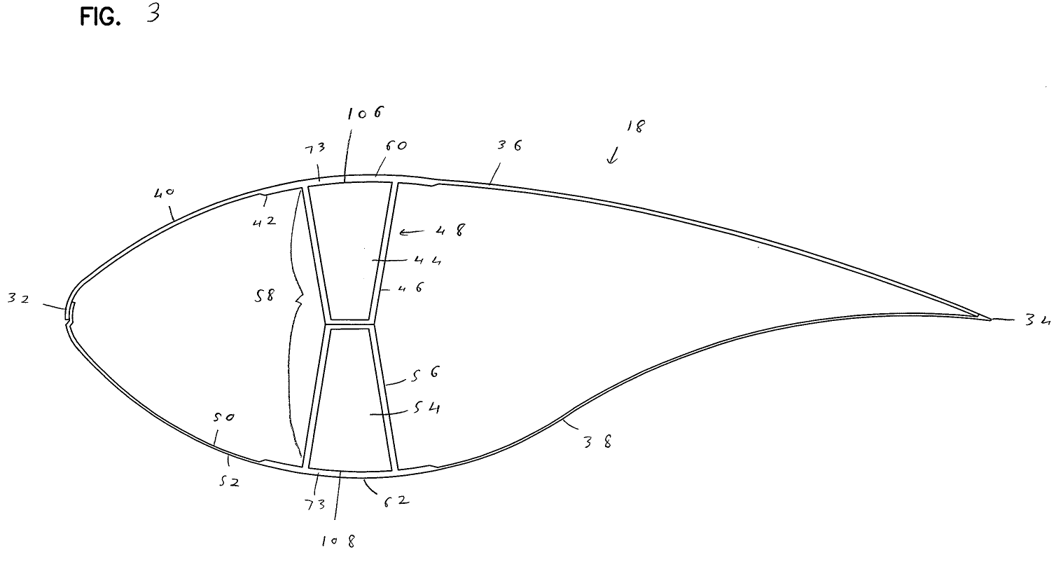

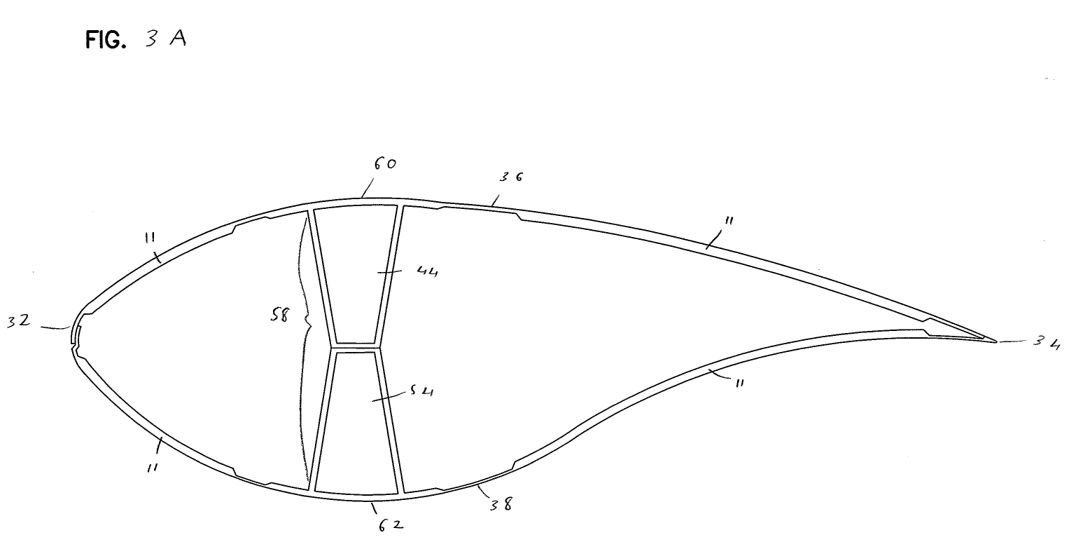

FIG. 3 is a cross-sectional view of the wind turbine blade 18 taken along line 3-3 of FIG. 2. Referring to the cross-section of the turbine blade 18, the turbine blade 18 defines a front end 32 that corresponds with the leading edge 24 of the body 22 and a rear end 34 that corresponds with the trailing edge 26 of the body 22. In the cross-sectional portion shown in FIG. 3, the turbine blade 18 defines an airfoil shape extending between the front end 32 and the rear end 34. It should be noted that the front end 32 and the rear end 34 may also be called the left side and the right side, respectively, of the wind turbine blade 18.

Still referring to FIG. 3, the wind turbine blade 18 is assembled from an upper shell 36 that is coupled to a lower shell 38. It should be noted that the terms “upper” and “lower” are simply used for ease of description and no limitations should be implied by the use of such terms. The upper shell is 36 bonded to the lower shell 38 adjacent the front end 32 and adjacent the rear end 34. According to one embodiment, the upper and the lower shells 36, 38 are also bonded to each other at a location between the front end 32 and the rear end 34 of the blade 18, as depicted in FIG. 3.

Still referring to FIG. 3, the upper shell 36 of the wind blade 18 is molded from a first upper portion 40 and a second lower portion 42. The first portion 40 and the second portion 42 are preferably formed as a single, unitary or monolithic piece such that no seams or discontinuities are located between these two structures. Also, as shown in FIG. 3, an insert 44 is integrally molded into the upper shell 36. The portion of the upper shell 36 that envelops the insert 44 defines a first spar portion 46 of the wind blade 18. The seamlessly formed first spar portion 46, along with the enveloped insert 44, provides a reinforcement structure 48 for the wind blade 18.

Still referring to FIG. 3, similar to the upper shell 36, the lower shell 38 of the wind blade 18 is molded from a third upper portion 50 and a fourth lower portion 52. The third and fourth portions 50, 52 are also preferably formed as a single, unitary or monolithic piece such that no seams or discontinuities are located between these two structures. A second insert 54 is integrally molded into the lower shell 38. The portion of the lower shell 38 that envelops the insert 54 defines a second spar portion 56 of the wind blade 18. As in the upper shell 36, a seamless connection is provided with the second spar portion 56.

The spar 46 of the upper shell 36 and the spar 56 of the lower shell 38 are bonded to each other to form a main reinforcement structure 58 extending generally the entire thickness from an outermost surface 60 of the upper shell 36 to an outermost surface 62 of the lower shell 38. The main reinforcement structure 58 includes the first and the second spar portions 46, 56 that envelop the first and second inserts 44, 54, respectively.

As noted above, the upper and the lower shells 36, 38 are each molded as a single, unitary piece such that no seams or discontinuities are located between the structures forming the upper and the lower shells 36, 38. Preferably, no separate fasteners or adhesive are provided at the connection locations between the first and second portions 40, 42 of the upper shell 36 and between the third and fourth portions 50, 52 of the lower shell 38.

The upper shell 36 and the lower shell 38 are preferably fabricated from resin enveloped fiber reinforced plastic material. The connection locations between the structures forming the upper shell 36 and the lower shell 38 preferably consist of continuous, uninterrupted thicknesses of the fiber reinforced plastic material and resin infused therein.

The term “seamless” is intended to mean that the connection locations are provided by continuous, uninterrupted portions of fibrous reinforced plastic material.

Preferably, each of the upper and the lower shells 36, 38 are formed by a molding process such as an injection molding process or a resin transfer molding process. The phrase “resin transfer molding” is intended to include any type of molding process where a fibrous reinforcing material is positioned within a mold into which resin is subsequently introduced. U.S. Pat. No. 5,971,742, filed on Sep. 18, 1996 and entitled Apparatus For Molding Composite Articles, which is hereby incorporated by reference in its entirety, discloses an exemplary resin transfer molding process.

Another process suitable for the fabrication of the upper and lower shells 36, 38 of the wind turbine blade 18 of the present disclosure is described in U.S. Application Ser. No. 12/009,636, having a filing date of Jan. 18, 2008, the entire disclosure of which is incorporated herein by reference.

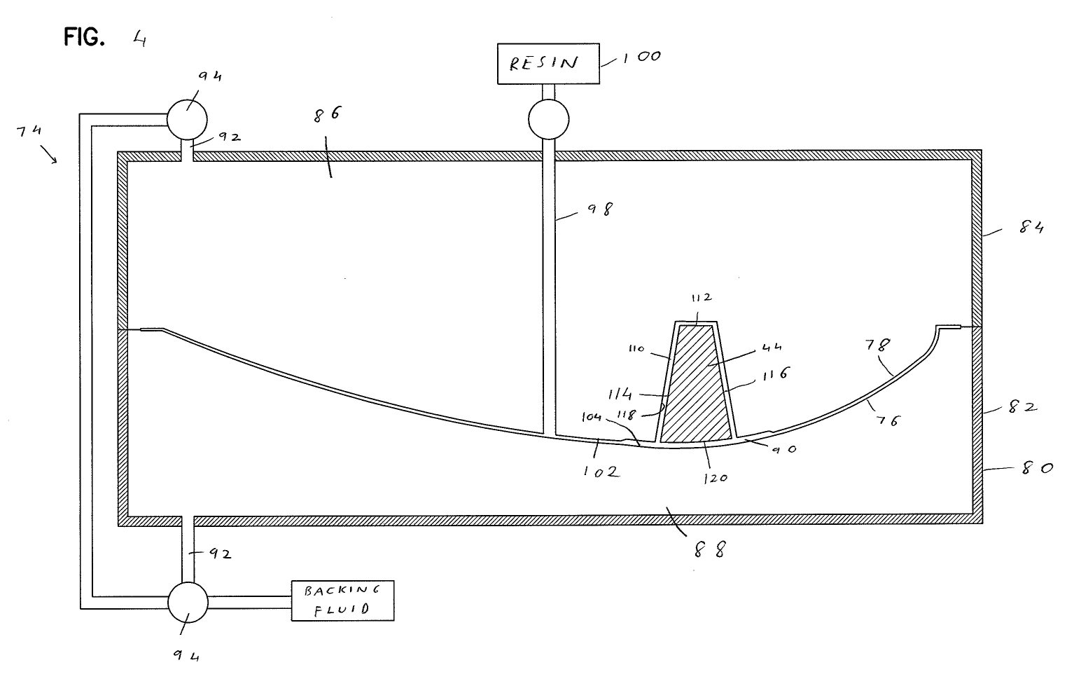

Referring now to FIGS. 4-6, a resin transfer molding method for making each of the upper and the lower shells 36, 38 of the wind turbine blade 18 is described. For simplicity, the method is described in detail with respect to only the upper shell 36 of the wind turbine blade 18, with the understanding that the method is equally applicable to the fabrication of the lower shell 38.

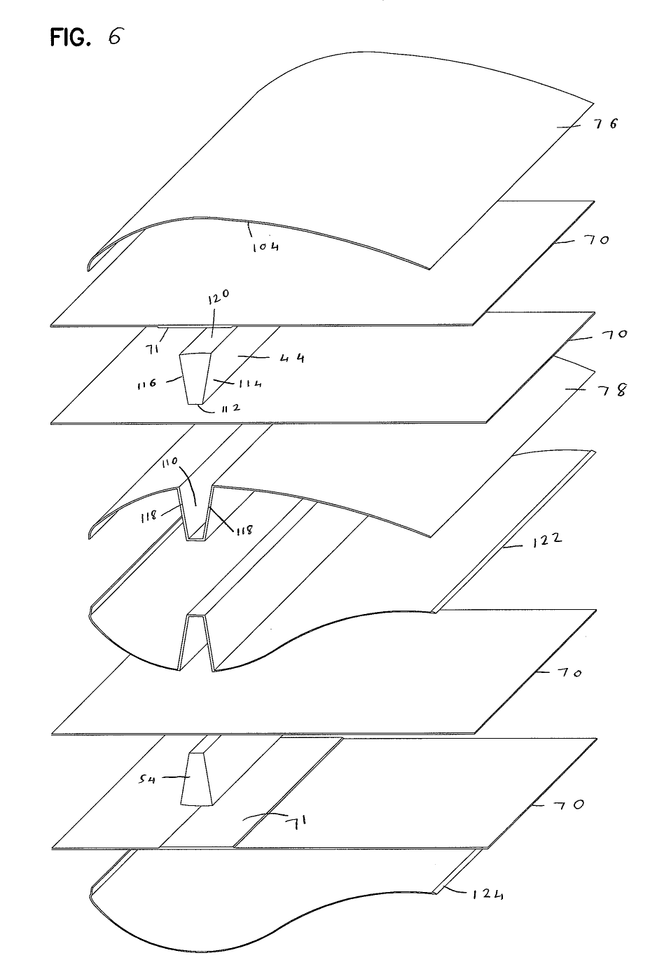

Generally, the method includes placing a pre-formed insert such as the insert 44 shown in FIG. 3 into a molding chamber or plenum. The insert 44 may be enclosed, covered or surrounded with layers or portions of fibrous reinforcing material. Similarly, at least portions of the mold are lined with fibrous reinforcing material 70 (see FIG. 6). The method also includes transferring resin into the molding chamber such that the resin envelops the fibrous reinforcing material 70. By using a pre-formed insert within the mold, the first portion 40 and the second portion 42 of the upper shell 36 can be simultaneously molded as a single piece within the molding cavity.

The insert pieces 44, 54 suitable for use in the upper and the lower shells 36, 38 are preferably made of a material such as low-density foam. The insert preferably includes a material having a lower density than the fibrous reinforcing material 70 and the resin used to envelop the fibrous reinforcing material 70. Each of the inserts 44, 54 used in the upper and lower shells 36, 38 may be constructed of one or more pieces. According to one embodiment, the insert may include a material having a density of about 2 to 10 lbs./ft.³.

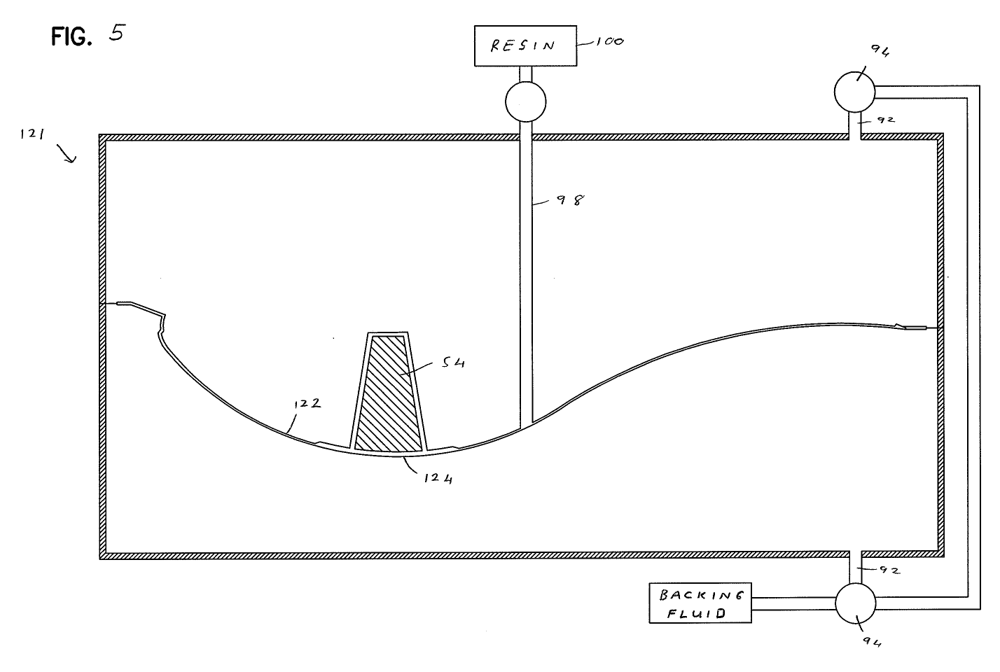

FIG. 4 is a schematic cross-sectional view of a resin transfer molding cell 74 suitable for fabricating the upper shell 36 of the wind turbine blade 18. FIG. 5 is a schematic cross-sectional view of a resin transfer molding cell 74 suitable for fabricating the lower shell 38 of the wind turbine blade 18.

Referring now to FIG. 4, the male and female mold pieces 76, 78 incorporated within the molding cell 74 for molding the upper shell 36 of the wind turbine blade 18 are illustrated. The cell 74 includes a substantially rigid outer support housing 80 having a bottom portion 82 and a removable top portion 84. The male mold piece 76 is secured to the bottom portion 82 of the housing 80 and the female mold piece 78 is secured to the top portion 84 of the housing 80. A top fluid chamber 86 is defined between the top portion 84 and the female mold piece 78 and a bottom fluid chamber 88 is defined between the bottom portion 82 and the male mold piece 76. When the top portion 84 of the housing 80 is mounted on the bottom portion 82 of the housing 80 as shown in FIG. 4, a molding chamber 90 is defined between the male mold piece 76 and the female mold piece 78.

In the embodiment of FIG. 4, the mold pieces 76, 78 are preferably semi-rigid membranes that are capable of at least slightly flexing when pressurized resin is injected into the mold chamber 90. In one particular embodiment, the male and female mold pieces 76, 78 may be made of sheets of metal. In other embodiments, the mold pieces 76, 78 can be made of other materials such as fiberglass, plastic, reinforced nylon, etc. To prevent the mold pieces 76, 78 from excessively deforming during the molding process, the top and bottom fluid chambers 86, 88 are preferably filled with a non-compressible liquid such as water. In this regard, the top and bottom fluid chambers 86, 88 preferably include inlets 92 for filling such chambers with the non-compressible liquid. The inlets 92 may be opened and closed by valves 94. By filling the top and bottom fluid chambers 86, 88 with non-compressible liquid and then sealing the chambers, the liquid retained within the chambers 86, 88 provides backing support to the mold pieces 76, 78 such that deformation of the mold pieces 76, 78 is resisted.

Still referring to FIG. 4, the cell 74 also includes structure for introducing resin into the molding chamber. For example, as shown, the cell 74 includes an injection sprue 98 that extends through the top portion 84 of the housing 80 for injecting resin into the molding chamber 90. Preferably, the sprue 98 is placed in fluid communication with a source of resin 100 (e.g., a source of liquid thermoset resin) such that resin can be pumped from the source of resin 100 through the sprue 98 into the molding chamber 90. While a single sprue 98 has been shown in FIG. 4, it will be appreciated that a large number of sprues can be provided through both the top and bottom portions 84, 82 of the support housing 80 to provide uniform resin flow throughout the molding chamber 90 in forming a large wind turbine blade upper shell 36.

It will be appreciated that the cell 74 can include a variety of additional structures for enhancing the molding process. For example, the cell 74 can include a heating/cooling mechanism for controlling the temperature of the fluid contained in the top and bottom fluid chambers 86, 88. Additionally, the top and bottom fluid chambers 86, 88 can include closeable vents for allowing air to be bled from the fluid chambers as the fluid chambers are filled with liquid. Furthermore, the molding chamber 90 can include vents for bleeding resin from the molding chamber 90 once the molding chamber has been filled with resin.

To manufacture the upper shell 36 of the wind blade 18 using the cell 74, the cell 74 is opened and the reinforcement insert 44 is placed within the molding chamber 90. In some embodiments, fibrous reinforcing material may be provided that directly surrounds or covers the insert 44. Preferably, fibrous reinforcing material 70 is also laid above the insert 44 along the top surface 102 of the female mold 78, and below the insert 44 along the bottom surface 104 of the male mold 76. For example, FIG. 6 shows an exploded view of portions of the male and female mold pieces for both of the upper and the lower shells 36, 38 with a first portion of the fibrous material 70 positioned between the insert 44 and the male mold piece 76, and a second portion of the fibrous reinforcing material 70 positioned between the insert 44 and the female mold piece 78 for each of the cells for upper and lower shells 36, 38. As shown in FIG. 6, thickened regions 71 of fibrous reinforcing material 70 may be provided to form a spar cap 73 of the upper and lower shells 36, 38 of the wind turbine blade 18. The spar caps 73, as shown in FIG. 3, may be formed along the top surface 106 of the insert 44 in the upper shell 36 and along the bottom surface 108 of the insert 54 in lower shell 38. More resin is provided at these thickened regions 71 of the fibrous reinforcing material 70 to form a stronger envelope.

After the insert 44 and fibrous material 70 have been positioned in the cell 74, the cell 74 is closed such that the insert 44 and the fibrous reinforcing material 70 are enclosed within the molding chamber 90. Thereafter, resin is injected or otherwise transmitted into the molding chamber 90 through the sprue 98.

Prior to the resin injection process, the top and bottom fluid chambers 86, 88 of the cell 74 are preferably filled with non-compressible liquid. The filled chambers 86, 88 provide back support to the mold pieces 76, 78 such that deformation of the mold pieces during the pressurized resin injection process is resisted.

When the cell 74 is closed, the insert 44 fits within the first gap 110 defined by the female mold piece 78. The inwardly facing surfaces of the insert 44 including the bottom surface 112 and the right and left side surfaces 114, 116 oppose the walls 118 defined by the gap 110 of the female mold 78. The planar surface 104 of the male mold 76 opposes the planar top surface 120 of the insert 44.

After the cell 74 has been closed and the backing chambers 86, 88 have been filled with fluid, the resin is injected or otherwise transferred into the mold chamber 90. As the resin enters the mold chamber 90, the resin envelops and impregnates the reinforcing material 70 contained within the mold chamber 90. Once the molding chamber 90 has been filled with resin, the resin within the chamber is allowed to cure within the cell. As the resin cures, the resin enveloped fibrous reinforcing material hardens to form the first and second portions 40, 42 of the upper shell 36 of the wind turbine blade 18 including the insert reinforced spar structure 46 formed into the upper shell 36.

In certain exemplary methods, a vacuum may be used to move resin through the fibrous reinforcing material 70. During the injection process, the mold chamber 90 may communicate with a vacuum system (not shown) to create a vacuum in the molding chamber 90. The vacuum system may include a vacuum pump, as know in the art. The pump reduces the pressure, relative to the ambient pressure, in the mold chamber 90. Alternatively, any suitable arrangement can be employed for reducing the pressure in the mold chamber 90 relative to the ambient pressure. After a vacuum has been drawn in the mold chamber 90, resin may be injected through the injection sprues 98 that run into the mold chamber 90. The vacuum may be maintained until the resin is cured.

By practicing the above described method, the first and second portions 40, 42 of the upper shell 36 can be simultaneously formed as a single seamless piece within the molding chamber 90. By forming the first and second portions 40, 42 of the upper shell 36 as a single piece, numerous process steps typically required by prior art manufacturing techniques can be eliminated thereby greatly enhancing manufacturing efficiency.

To enhance the aesthetic appearance of the upper shell 36 of the wind turbine blade 18, the male and female mold pieces 76, 78 may be coated with a layer of gel coat prior to enclosing the insert 44 and the fibrous reinforcing material 70 within the cell 74. Additionally, barrier coat layers may also be provided over the layers of gel coat for preventing the fibrous reinforcing material from printing or pressing through the gel coat layers.

As discussed previously, the insert 44 may be covered with a fibrous reinforcing material affixed to the insert 44 before the insert 44 has been placed in the cell 74. It will be appreciated that in alternative embodiments, the insert 44 can be covered with fibrous reinforcing material 70 by placing or laying the fibrous reinforcing material 70 about the insert 44 within the cell 74.

Also, it will be appreciated that the various material thicknesses shown in FIG. 6 are diagrammatic (i.e., not to scale), and that in actual practice the material thicknesses can be varied at different locations within the cell 74 to provide the resultant wind turbine blade 18 with desired strength characteristics. For example, as discussed above, in certain embodiments, a thicker layer 71 of fibrous reinforcing material 70 can be used in areas of the first portion 40 of the upper shell 36 such as areas defining a spar cap 73 (see FIG. 3). Similarly, the thickness of fibrous reinforcing material 70 can also be varied for the various areas of the second portion 42 of the upper shell 36 such as those areas surrounding the insert 44 (see FIG. 3).

While any number of different types of resins could be used in practicing the inventive aspects of the present disclosure, a preferred thermoset resin may be a blended polyester resin. In other embodiments, the resin may be an epoxy resin. In other embodiments, the resin may be a vinylester resin. Additionally, the fibrous reinforcing material 70 can include any number of different types of material such as glass, graphite, aramid, etc. Furthermore, the fibrous reinforcing material 70 can have a chopped configuration, a continuous configuration, a sheet configuration, a random configuration, a layered configuration or an oriented configuration.

As noted above, even though the molding process was described with respect to the upper shell 36, a similar method to that described above can be implemented in molding the lower shell 38 of the wind turbine blade 18. For example, FIG. 5 illustrates a resin transfer molding cell 121 suitable for fabricating the lower shell 38 of the wind turbine blade 18, wherein the cell 121 includes male and female mold pieces 122, 124 for molding the lower shell 38.

It should be noted that in other embodiments of the wind turbine blade, additional reinforcement materials may be used to further strengthen the upper shell 36 and the lower shell 38. As shown in the cross-sectional view in FIG. 3A, reinforcement materials 11 (i.e., core materials) such as balsa wood, engineered three-dimensional fiber reinforced cores, etc. may be integrally molded into the upper and lower shells 36, 38. The core materials 11, as shown in FIG. 3A, may extend along or parallel to the outermost surface 60 of the upper shell 36 and the outermost surface 62 of the lower shell 38. During molding, the core materials 11 may be placed between the first portion of the fibrous reinforcement material 70 and the second portion of the fibrous reinforcement material 70 in each of the upper and lower shells 36, 38 (see FIG. 6). The core materials 11 may be provided in addition to the main reinforcement structure 58 formed by the first and second spar portions 46, 56 including inserts 44, 54, extending generally the entire thickness from the outermost surface 60 of the upper shell 36 to the outermost surface 62 of the lower shell 38. As seen in FIG. 3A, the core materials 11 may be provided between both the front end 32 and the main reinforcement structure 58 of the wind turbine blade 18 and the rear end 34 and the main reinforcement structure 58 of the wind turbine blade 18. According to one exemplary embodiment, the core materials 11 may be about ¾ to 1 inch in thickness.

Although in the foregoing description of the wind turbine blade 18 and manufacturing method thereof, terms such as “top”, “bottom”, “upper”, “lower”, “front”, “rear”, “right”, and “left” may have been used for ease of description and illustration, no restriction is intended by such use of the terms.

With regard to the foregoing description, it is to be understood that changes may be made in detail, especially in matters of the construction materials employed and the shape, size and arrangement of the parts without departing from the scope of the present disclosure. It is intended that the specification and depicted aspects be considered exemplary only.

1. A wind turbine blade comprising:
an upper shell defining a first width extending between a right side and a left side of the upper shell, the upper shell defining a first outermost surface of the wind turbine blade, the upper shell including a first portion molded to a second portion by a seamless connection extending along at least a majority of the width of the upper shell such that there are no discontinuities located between the first portion and the second portion, the first portion and the second portion made of a fiber reinforced resin construction;
a first insert enveloped within the upper shell between the first portion and the second portion, the first insert defining a density lower than the density of the fiber reinforced resin material, the enveloped first insert defining a first spar portion of the upper shell extending in a direction away from the first outermost surface;
a lower shell defining a second width extending between a right side and a left side of the lower shell, the lower shell defining a second outermost surface of the wind turbine blade, the lower shell including a third portion molded to a fourth portion by a seamless connection extending along at least a majority of the width of the lower shell such that there are no discontinuities located between the third portion and the fourth portion, the third portion and the fourth portion made of the fiber reinforced resin construction;
a second insert enveloped within the lower shell between the third portion and the fourth portion, the second insert defining a density lower than the density of the fiber reinforced resin material, the enveloped second insert defining a second spar portion of the lower shell extending in a direction away from the second outermost surface;
wherein the upper shell is bonded to the lower shell adjacent the right and left sides of the upper shell and the lower shell, respectively; and
wherein the first spar portion is bonded to the second spar portion.

2. A wind turbine blade according to claim 1, wherein the first spar portion bonded to the second spar portion form a reinforcement structure extending substantially the entire distance between the first outermost surface and the second outermost surface.

3. A wind turbine blade according to claim 1, wherein the first and second spar portions are positioned at a location between the right and left sides of the upper and lower shells, respectively.

4. A wind turbine blade according to claim 1, wherein the first and second inserts include foam material.

5. A wind turbine blade according to claim 1, wherein the first and second inserts include a material having a density of about 2 to 10 lbs./ft.³

6. A wind turbine blade according to claim 1, wherein each of the first and second inserts is formed from one piece.

7. A wind turbine blade according to claim 1, wherein at least one of the upper shell and the lower shell defines a thickened portion of fiber and resin material between the insert and the outermost surface of the wind turbine blade.

8. A method for molding at least a section of a wind turbine blade, the method comprising:
arranging in a spaced apart opposed relationship a first mold section comprising a first semi-rigid membrane removably mounted to a first rigid housing to define a first fluid tight chamber therein and a second mold section comprising a second semi-rigid membrane removably mounted to a second rigid housing to define a second fluid tight chamber therein;
defining a mold plenum between the first and second semi-rigid membranes when the first and second mold sections are closed together to mold the article;
filling the first and second fluid tight chambers with a substantially non-compressible backing fluid to support each membrane during injection of resin;
positioning an insert in the mold plenum defined between the first and second semi-rigid membranes;
providing fibrous reinforcing material that surrounds the insert within the mold plenum, the fibrous reinforcing material including portions positioned between the first semi-rigid membrane and the insert, the fibrous reinforcing material also including portions positioned between the second semi-rigid membrane and the insert, each of the fibrous reinforcing material portions positioned between the first and second semi-rigid membranes and the insert being in contact with the insert;
closing the first and second mold sections towards each other to sandwich the fibrous reinforcement material around the insert;
injecting resin into the mold plenum such that the resin envelops the fibrous reinforcing material and the insert, wherein the insert defines a lower density than the resin enveloping the fibrous reinforcing material; and
curing the resin by heating at least one of the backing fluid to produce the section of a wind blade, wherein the section is molded as a single, unitary piece.

9. The method of claim 8, wherein the molded section is an upper shell of the wind turbine blade.

10. The method of claim 8, wherein the molded section is a lower shell of the wind turbine blade.

11. The method of claim 8, wherein the insert includes a foam material.

12. The method of claim 8, wherein the insert includes a material having a density of about 2 to 10 lbs./ft.³

13. The method of claim 8, wherein the insert includes an elongated portion including a top surface, a bottom surface, and two side surfaces, an upper surface of the wind turbine blade section being molded by portions of the resin enveloped fibrous reinforcing material that cover the top surface of the insert and an elongate support structure of the wind turbine blade section being formed by portions of the resin enveloped fibrous reinforcing material that cover the bottom and side surfaces of the insert.

14. The method of claim 8, further comprising providing a finish layer within at least one of the first mold section and the second mold section to form a finished outer coat on an exterior surface of the molded wind turbine blade section.

15. The method of claim 14, wherein the finish layer includes gel coat.

16. The method of claim 8, further comprising drawing a vacuum through the mold plenum to move the resin through the fibrous reinforcing material.

17. The method of claim 8, wherein the non-compressible backing fluid is water.

18. The method of claim 8, further comprising bonding the molded wind turbine blade section to a second similarly molded wind turbine blade section to form a wind turbine blade.

19. A method for molding at least a section of a wind turbine blade comprising:
molding an upper shell defining a first width extending between a right side and a left side of the upper shell, the upper shell defining a first outermost surface of the wind turbine blade, the upper shell including a first portion molded to a second portion by a seamless connection extending along at least a majority of the width of the upper shell such that there are no discontinuities located between the first portion and the second portion, the first portion and the second portion molded of a fiber reinforced resin construction;
integrally molding a first insert within the upper shell between the first portion and the second portion, the first insert defining a density lower than the density of the fiber reinforced resin material, the enveloped first insert defining a first spar portion of the upper shell extending in a direction away from the first outermost surface;
molding a lower shell defining a second width extending between a right side and a left side of the lower shell, the lower shell defining a second outermost surface of the wind turbine blade, the lower shell including a third portion molded to a fourth portion by a seamless connection extending along at least a majority of the width of the lower shell such that there are no discontinuities located between the third portion and the fourth portion, the third portion and the fourth portion molded of the fiber reinforced resin construction;
integrally molding a second insert within the lower shell between the third portion and the fourth portion, the second insert defining a density lower than the density of the fiber reinforced resin material, the enveloped second insert defining a second spar portion of the lower shell extending in a direction away from the second outermost surface;
bonding the upper shell to the lower shell adjacent the right and left sides of the upper shell and the lower shell, respectively; and
bonding the first spar portion to the second spar portion at a location positioned between the right side and the left side of the upper and lower shells.
